(19) United States
(12) Patent Application Publication
(10) Pub. No.: US 2026/0077526 A1
(43) Pub. Date: Mar. 19, 2026

(54) EXCESS MESH TRIMMER

(71) Applicant: Erdman Automation Corporation, Princeton, MN (US)

(72) Inventors: Morgan W. Donohue, North Oaks, MN (US); Peter J. Kroll, Saint Stephen, MN (US); Ryan Lloyd Henry Roberts, Isanti, MN (US); Andrew D. Peterson, Zimmerman, MN (US)

(21) Appl. No.: 18/889,156

(22) Filed: Sep. 18, 2024

(51) Int. Cl. B26D 1/12; B26D 7/01; E06B 9/52

(52) U.S. Cl. CPC B26D 1/125; B26D 7/015; E06B 9/52

(57) ABSTRACT

An excess screen mesh trimmer to trim excess mesh from flexible screen frames to which the mesh is at least partially fused, including a trimmer assembly including at least a first rotating blade having a sharpened outer perimeter edge and a screen frame supporting assembly that supports a flexible screen frame proximate the trimmer assembly and proximate the at least first rotating blade perimeter edge in a parallel orientation to a portion of the screen frame A supporting frame supports the trimmer assembly and the screen supporting frame. Also, a method of trimming excess mesh from flexible screen frames placing the flexible screen frame in contact with a portion of an infeed fence and advancing the flexible screen frame in a direction parallel to the portion of the infeed fence and severing the excess screen mesh from the flexible screen frame proximate the flexible screen frame.

### TECHNICAL FIELD

Embodiments of the invention relate generally to removable window and door screens. In particular, example embodiments of the invention relate to the manufacturing of removable window screens that include a flexible frame that is resilient and a flexible mesh material that is bonded to the flexible frame.

### BACKGROUND

Fenestrations exist in buildings to permit ingress and egress, entry of fresh air and light. Screens have been used in these openings for many years to permit the entry and exit of air while excluding insects, debris, leaves and other undesired materials. Currently screens generally include a mesh material supported by a frame that holds the mesh material taut and facilitates insertion of the screen into the frame of a fenestration. For the purposes of this application, the term fenestration refers to any opening in the outside envelope of a building structure including but not limited windows and doors.

In many modern window screens a fiberglass mesh is supported in a frame. Other mesh materials commonly include nylon, polyester, bronze, stainless steel, aluminum, copper, brass and galvanized steel. Meshes made of fiberglass, nylon and polyester are generally quite flexible, while meshes that are made of stainless steel, aluminum, copper, brass and galvanized steel are relatively less flexible.

Screen frames are commonly made of rigid materials such as extruded aluminum, wood, steel or polymers. Occasionally, screens are made without a perimeter frame. In this case the screens are stretched taut over an opening often by a roller under spring tension.

More recently, other screen frames are made of flexible materials with resilient qualities. For example, some flexible screen frames are made from resilient steel rod that is coated with a polymer material. In many cases, the screen mesh is fused to the flexible screen frame by the application of heat which renders the polymer material of the screen frame, the screen mesh or both at least partially molten during the manufacturing of the screen. When the polymer material returns to its non-molten state the screen mesh is fused and strongly bound to the screen frame. Similar to some earlier methods, this bonding procedure requires that the screen mesh to be applied is larger than the screen frame. So, some screen material is left overhanging the perimeter of the screen frame. This excess screen mesh material is trimmed from the screen frame prior to the finished window screen product being released.

Such flexible screens are typically inserted into rigid fenestration frames by distorting the flexible window screen, generally by pushing inwardly on parallel rectilinear sides of the flexible window screen and then inserting the flexible window screen into grooves that surround the rigid fenestration frame on an inside of the fenestration frame. Similarly, flexible screens are generally removed by distorting the screen frame which then permits taking the screen frame out of the grooves. To facilitate this, the flexible screen frame is generally resiliently biased outwardly toward an approximately rectangular shape.

Currently, manufacturing of flexible window screen frames and flexible window screens is largely done by manual processes that are labor-intensive. These processes tend to be inefficient and time-consuming. Thus, rapid production of flexible screen frames and screens is not available.

Flexible screen frames are formed from spring metal such as spring steel that is bent to the shape of the screen and so that terminal ends of the metal material abut one another. Generally, the abutting ends of the flexible screen frame are located away from corners of the frame but not at a center of a straight side of the screen frame. The spring material is coated with a polymer material such as polyvinylchloride (PVC) also referred to as vinyl. Other polymer material coatings are, of course, possible.

Flexible screen frames are formed of spring material so that they can be deformed inwardly, inserted into a window frame and then be held in place by the resilience of the flexible screen frame material springing outwardly. Deformation of the flexible screen frame is generally accomplished by pressing inwardly on two opposing straight sides of the screen frame.

The abutting terminal ends of the shaped frame are welded to each other to form a closed geometric shape, most commonly a rectangle or a square. Resistance welding is commonly used.

To facilitate the welding of the abutting ends of the frame, the polymer coating material must first be removed from the metal core material. Failure to remove the polymer material interferes with establishing electrical contact with the metal core of the frame material necessary for electrical welding and may result in contamination of any weld that is performed with the coating material present. Contaminated welds are often of inferior quality and may not hold up to the flexing encountered during insertion and removal of the flexible screen frame from a window or door structure.

Following welding of the abutted metal core ends it is good practice to clean the area of the weld to remove weld flash or spatter and possibly to mitigate any mushrooming of the abutted ends that may occur during the welding process.

It is also desirable to apply a new polymer coating over the stripped and welded area of the frame to mitigate corrosion and to facilitate adhesion of screen mesh in the area surrounding the weld. This is commonly accomplished by slipping a portion of heat shrink tube over the frame material prior to welding to join the abutting ends and moving the heat shrink material away from the portion to be welded until it is welded, cleaned and cooled. After the welding is performed, subject post weld cleaning and cooled the heat shrink tube is located to cover the previously stripped and welded portion and heat is applied to shrink it. The level of heat required to shrink the heat shrink tube is considerably less than that related to welding.

Fusing of screen mesh material to flexible screen frame material requires the application of heat and pressure to the materials to create a plastic welded permanent fusion between the screen mesh material and the flexible screen frame material. This creates a durable and self-securing flexible framed window screen which is less prone to damage and easier to handle than more conventional screen frames.

These processes are typically manually performed.

Accordingly, there is still room for improvement in the manufacturing of flexible window screens.

### SUMMARY

Example embodiments of the invention improve on many of the above discussed deficiencies of the prior art.

According to an example embodiment of the invention, a mesh trimmer generally includes rotating blades that cut off excess mesh material overhanging flexible screen frames to which the mesh material has been fused with a scissor like action. The mesh trimmer further includes a horizontal or vertical supporting structure that supports the flexible screen frame from which excess mesh material is to be trimmed. While most of the discussion in this application will refer to a vertically oriented excess mesh trimmer, this should not be considered limiting as the excess mesh trimmer may cause the screen frame to be oriented horizontally as well. In the context of example embodiments of the invention and this application, vertical means that the screen frame to be trimmed is supported oriented within approximately 15° of a perfectly vertical orientation.

The mesh trimmer generally includes a supporting frame, a trimmer assembly and a screen frame supporting assembly.

The supporting frame generally includes a structure that engages the ground and provides support for the trimmer assembly and the screen frame supporting assembly.

The trimmer assembly, according to an example embodiment, includes a trimmer head. The trimmer head includes rotating blades, a trimmer motor and a trimmer transmission. The trimmer motor drives the rotating blades via the trimmer transmission.

The rotating blades generally include at least two rotating blades that contact or nearly contact one another proximate a perimeter thereof and are, in an example embodiment, polygonal in shape. The two rotating blades may also be circular. It is also possible in the context of the invention to utilize a single rotating blade along with a fixed blade. The rotating blades rotate in opposing directions.

According to an example embodiment the rotating blades are polygonal, for example octagonal, in shape with each straight edge being sharpened. The rotating blades may be formed for example from metal or another material of sufficient hardness and rigidity to form a cutting edge sufficiently sharp to shear screen mesh material. Each rotating blade rotates on a shaft. The two shafts are located a distance apart so that the edges of the rotating blades make contact with each other.

A trimmer motor drives the rotating blades and is coupled to the rotating blades via a trimmer transmission. According to an example embodiment of the invention, the trimmer transmission includes two pinion gears supported on each of two rotating blade shafts that cause the rotating blades to rotate in opposing directions. The trimmer transmission may include other mechanisms to rotate the trimmer blades in opposing directions known to those skilled in the art. The structure of the rotating trimmer blades facilitates a scissor like cutting action when cutting the mesh material, the rotating trimmer blades tend to draw the mesh inwardly for cutting but, according to an example embodiment of the invention, may not be sufficient to advance the position of the screen frame being trimmed independent of some outside force.

According to an example embodiment of the invention, the screen frame may be advanced manually by an operator in a direction parallel to a side of the screen frame being trimmed until excess mesh of the first side is removed. The operator then can the rotate the screen frame by ninety degrees and trim a second side of the screen frame. This process continues until all sides of the screen frame are trimmed of excess mesh material.

According to another automated example embodiment of the invention, the screen frame with its bonded mesh may be mechanically driven to advance it relative to the mesh trimmer head.

The screen frame support assembly generally includes, in an example embodiment, an infeed fence, an outfeed fence, supporting rollers and magnets.

According to an example embodiment, the infeed fence and the outfeed fence are relatively short in length. That is shorter than the length of a side of the smallest flexible screen frame intended to be trimmed. The short length of the infeed fence, in particular, mitigates a concern of excess mesh becoming caught between the infeed fence and the screen frame. According to an example embodiment, the infeed fence is trapezoidal in shape. The trapezoidal shape of the infeed fence is oriented so that the longest side of the trapezoid is that the upper edge of the trapezoid and in closest proximity to the screen frame to be trimmed. According to a further example embodiment, the infeed fence may have a beveled corner proximate the corner first encountered by the flexible screen frame to be trimmed which further mitigates the risk that excess mesh becomes caught between the infeed fence and the screen frame.

The outfeed fence, according to an example embodiment is a simple linear structure. The outfeed fence is, for example, shorter than the length of a side of the smallest flexible screen frame intended to be trimmed.

The screen frame support assembly, in an example embodiment, further includes supporting rollers and magnets. According to an example embodiment, the rollers are arranged so that a side of a screen frame to be trimmed rests on the rollers but is held off from the surface in which the magnets are embedded. The magnets, for example permanent magnets, are located in some embodiments so that they alternate between the supporting rollers and keep the screen frame material positioned over the rollers and mitigate the likelihood that the screen frame material will fall off. According to an example embodiment, the magnets do not contact the screen frame material but the screen frame material is within the attractive magnetic influence of the magnets and drawn toward the rollers by attractive influence of the magnets. This facilitates the use of the short infeed fence and the short outfeed fence and mitigates the risk that excess mesh may become caught between the fences and the flexible screen frame thereby leaving a larger than desired amount of excess mesh on the flexible screen frame.

According to another example embodiment a magnetic mesh support is present. The magnetic mesh support grips the mesh proximate an upper edge of the screen frame being trimmed to mitigate flopping down of the excess mesh from above.

A further example embodiment of the invention includes a method of trimming excess mesh material from a flexible screen frame. The method includes passing the flexible screen frame with screen mesh fused to the screen frame proximate at least one rotating cutter that severs the excess mesh material proximate the metal screen frame material.

According to a further example embodiment the method includes passing the flexible screen frame with screen mesh fused to the screen frame proximate to rotating cutters that sever the excess mesh material.

In a further example embodiment, the method includes rotating the cutters in opposing directions and cutting the mesh material between the two rotary cutters.

In a further example embodiment, the two rotary cutters are selected or made to be polygonal.

In a further example embodiment, the rotary cutters are selected or made to be octagonal.

In a further example embodiment, the method includes supporting the screen frame on an infeed fence and outfeed fence wherein the infeed fence and the outfeed fence are shorted than a side of the screen frame supported for trimming.

In another example embodiment, the method includes supporting the screen frame by operation of rollers and magnets wherein the rollers and magnets are alternately positioned.

A further example embodiment includes advancing the screen frame and mesh material manually.

A further example embodiment includes advancing the screen frame and mesh material by a driving mechanism.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of a mesh trimmer according to an example embodiment of the invention;

FIG. 2 is a front elevational view of the mesh trimmer as depicted in FIG. 1;

FIG. 3 is a side elevational view of the mesh trimmer as depicted in FIG. 1;

FIG. 4 is a perspective view of a mesh trimmer head according to an example embodiment of the invention;

FIG. 5 is a side elevational view of the mesh trimmer head as depicted in FIG. 4;

FIG. 6 is a plan view of the mesh trimmer head as depicted in FIG. 4; and

FIG. 7 is a further perspective view of the mesh trimmer head.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

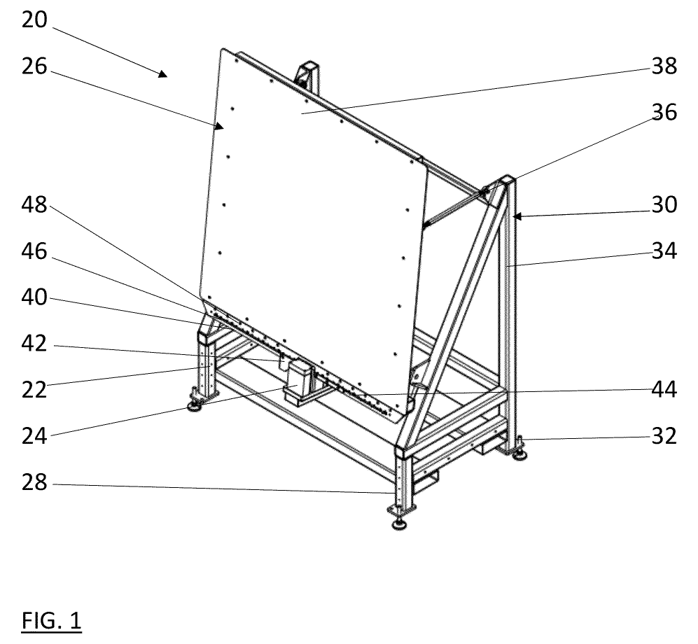

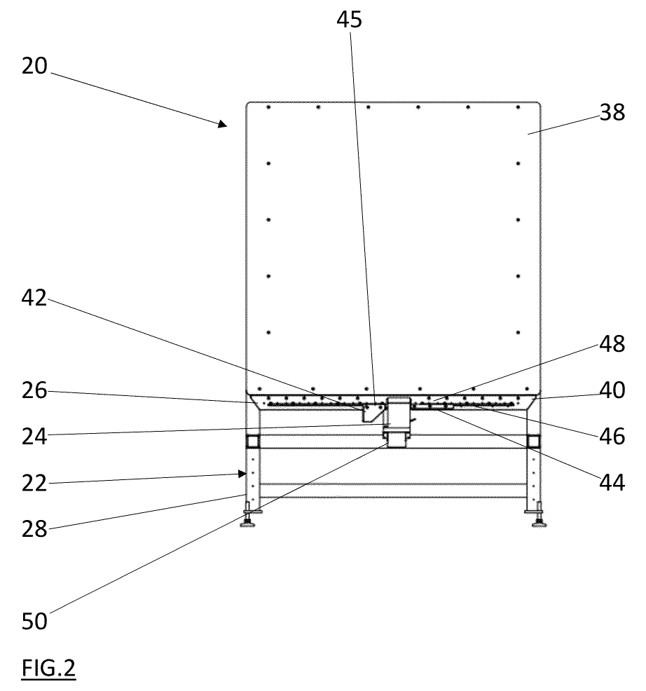

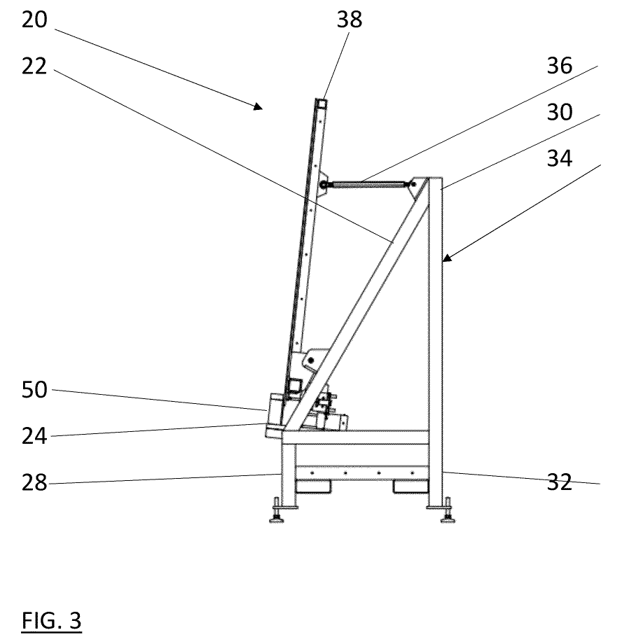

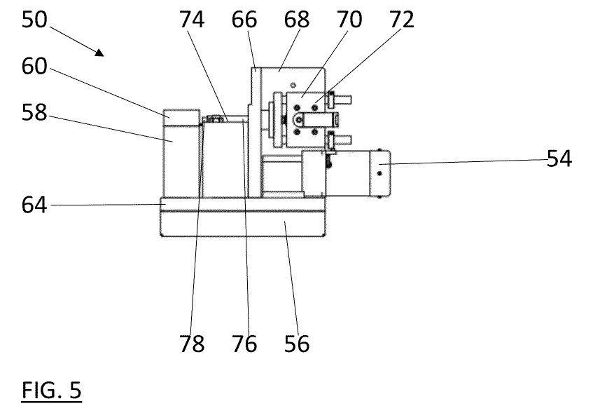

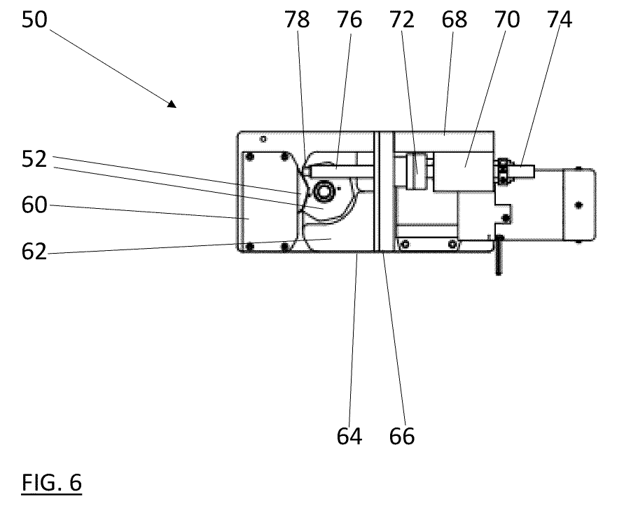

Referring to FIGS. 1-6, mesh trimmer 20 according to an example embodiment of the invention generally includes supporting frame 22, trimmer assembly 24 and screen frame supporting assembly 26.

In the depicted embodiment, supporting frame 22 generally includes ground engaging portion 28 and angled upper portion 30. Ground engaging portion 28 generally includes legs 32. Angled upper portion 30 generally includes triangular supports 34, adjusters 36 and horizontal support 38.

Legs 32 support angled upper portion 30. Triangular supports extend upwardly from ground engaging portion 28 and are coupled by horizontal support 38. Adjusters 36 extend outwardly and forwardly from triangular supports 34.

Screen frame supporting assembly 26 generally includes vertical table 38 and window frame support 40.

Vertical table 38 is oriented to be substantially vertical. That is, within approximately 15° of absolute vertical.

Window frame support 40 generally includes infeed fence 42, outfeed fence 44, supporting rollers 46 and supporting magnets 48.

Infeed fence 42, in the depicted embodiment, is positioned on the left side of window frame support 40. Outfeed fence 44 is located on the right side. Accordingly, in the depicted embodiment feed is from left to right. This, however, should not be considered limiting. This orientation can be reversed by one skilled in the art.

Infeed fence 42, in the depicted embodiment, is trapezoidal in shape with longest side 45 facing upwardly. Longest side 45 thus contacts a screen frame being trimmed.

This shape of infeed fence 42 mitigates the tendency of excess mesh to become caught between infeed fence 42 and a flexible window frame to which the excess mesh is attached.

Supporting rollers 46 extend outwardly from window frame support 40 and are located and oriented to support a flexible window frame being trimmed. Supporting magnets 48, according to an example embodiment, are slightly recessed relative to infeed fence 42, outfeed fence 44 and supporting rollers 46. Supporting magnets 48 are positioned so that a flexible window frame being trimmed is within the magnetic attractive influence of supporting magnets 48.

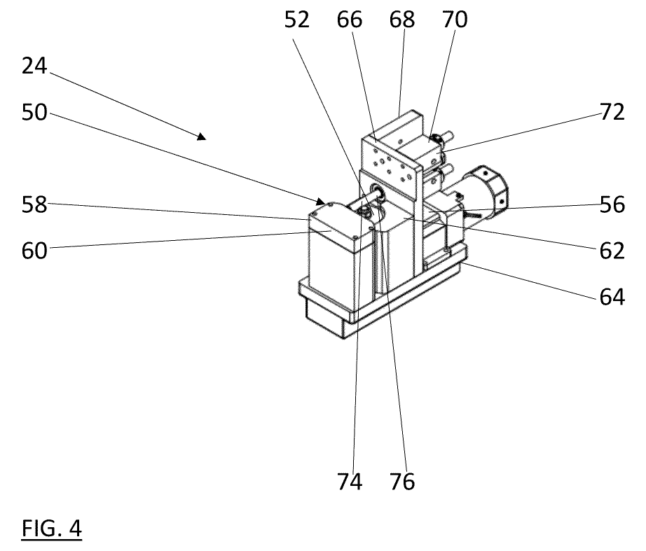

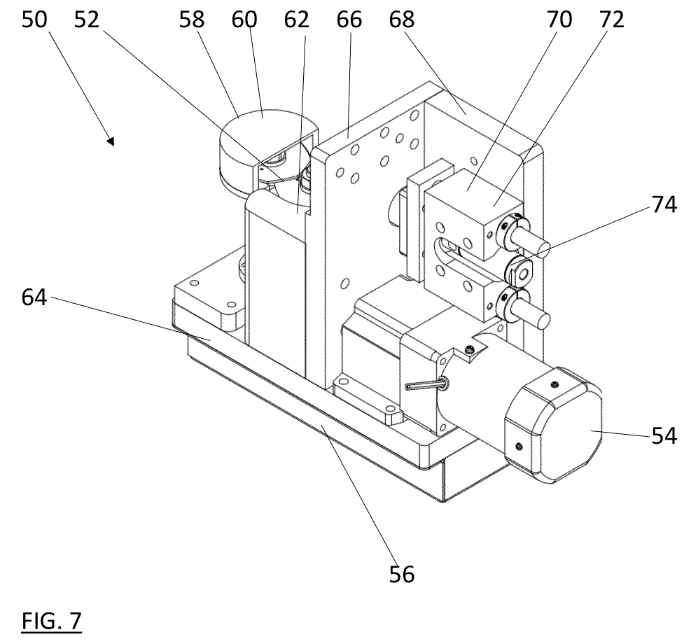

Referring primarily to FIGS. 4, 5, 6 and 7, trimmer assembly 24 generally includes Trimmer head 50. Trimmer head 50 generally includes rotating blades 52, trimmer motor 54, trimmer transmission 56 and housing 58. According to an example embodiment, two of rotating blades 52 are present. Rotating blades 52 are positioned so that perimeters thereof contact or overlap each other.

According to an example embodiment, rotating blades 52 are polygonal in shape. According to another example embodiment, rotating blades 52 are octagonal in shape. A perimeter of rotating blades 52 are sharpened. Rotating blades 52 are made from metal or another material of sufficient hardness and durability to cut screen mesh material. Rotating blades 52 may be made from different materials depending upon what sort of screen mesh material is to be trimmed. According to another example embodiment (not depicted) a single rotating blade 52 may be utilized in combination with a fixed blade.

Trimmer motor 54 drives rotating blades 52 via trimmer transmission 56. Typically, rotating blades 52 are driven in contrarotating directions. That is, one of rotating blades 52 is driven clockwise while the other of rotating blades 52 is driven counterclockwise. Blade housing 58 includes outer safety guard 60 and inner safety guard 62. Outer safety guard 60 and inner safety guard 62 together and close rotating blades 52 mitigating risk of operator injury while facilitating trimming of excess mesh material. Rotation of rotating blades 52 tends to draw excess mesh material into the blades. It is not expected that this alone is sufficient to advance a flexible screen frame to be trimmed forward.

Trimmer motor 54, trimmer transmission 56 and housing 58 are coupled to and supported by support plate 54, first vertical plate 66 and second vertical plate 68. First vertical plate 66 and second vertical plate 68 are oriented generally perpendicular to one another and generally perpendicular to support plate 54. First vertical plate 66 is between trimmer motor 54 and rotating blades 52.

Trimmer motor 54 is operably coupled to trimmer transmission 56 which drives rotating blades 52. Trimmer motor 54 Is also operably coupled to and powers mechanical frame driver assembly 70. Trimmer transmission 56, according to an example embodiment, transfers power from trimmer motor 54 to rotating cutters 52 both through vertical plate 66 and bypassing under support plate 54 and then back upwardly through support plate 54.

Mechanical frame hold down 70 includes hold down assembly 72, and hold down shaft 74. Hold down shaft 74 presents shaft portion 76 and frame engagement portion 78. According to an example embodiment of the invention, frame engagement portion 78 is smaller in diameter than shaft portion 76. Frame engagement portion 76 may optionally be textured or knurled to facilitate frictional engagement with a flexible screen frame. Alternately, shaft portion 76 may be rotated to drive the screen frame forward.

Hold down shaft 74 may be advanceable and retractable parallel to its axis to engage and disengage from a flexible screen frame to be moved for trimming.

According to a further example embodiment of the invention a method of trimming access screen mesh from flexible frame screen frame includes placing the flexible screen frame in contact with a portion of an infeed fence and a series of supporting rollers. The method further includes advancing the flexible screen frame in a direction parallel to the portion of the infeed fence. The method further includes bringing the excess screen mesh into contact with the tremor head including at least one rotating cutter. Upon reaching a corner of the flexible screen frame, the method includes rotating the flexible screen frame by approximately 90° the method further includes advancing a second side of the flexible screen frame parallel to the portion of the infeed fence.

The method may further include bringing the excess screen mesh into contact with to contrarotating rotating cutters.

The method may further include bringing the excess screen mesh into contact with two rotating cutters that are polygonal in shape.

According to an example embodiment, the method may further include resting the flexible screen frame on at least 1 of the infeed fence and and outfeed fence with the flexible screen frame in a substantially vertical orientation.

In a further example, the method may include resting the flexible screen frame on supporting rollers and within the attractive influence of magnets that are positioned such that the magnets do not count intact the flexible screen frame material.

The example method may further include advancing the flexible screen frame relative to the trimmer head manually. Additionally, the method may include advancing the flexible screen frame relative to the trimmer head by frictional engagement with a screen frame drive mechanism.

In addition, the method may include placing the screen frame in contact with a screen frame supporting assembly that is oriented from zero to fifteen degrees from absolute vertical.

In operation, and operator places a flexible screen frame to be trimmed of excess mesh on supporting frame 22 of mesh trimmer 20. The flexible screen frame is positioned in contact with infeed fence 42 and supporting rollers 46. Supporting magnets 48 assist in maintaining flexible screen frame in its proper position for trimming. Optionally, the operator can advance the flexible screen frame past trimmer assembly 24. As the flexible screen frame is advanced access screen mesh proximate the flexible screen frame passes between rotating blades 52. Rotating blades 52 cut off access screen mesh with a scissor like action thus separating it from flexible screen frame. As the flexible screen frame passes beyond rotating blades 52 of trimmer had 50 the flexible screen frame is supported by outfeed fans 44 and supporting rollers 46. Upon reaching a corner of the flexible screen frame being trimmed the flexible screen frame is rotated 90° and excess mesh on a second side of the flexible screen frame is trimmed in a similar fashion.

According to another example embodiment the flexible screen frame is advanced past trimmer assembly 24 by mechanical frame hold down 70. In this case the flexible screen frame is positioned so that frame engagement portion 78 of hold down shaft 74 frictionally engages the flexible screen frame material. As hold down shaft 74 keeps the flexible screen frame from rising as it advances past rotating blades 52 which are rotated by trimmer motor 54. Rotating blades 52 cut excess screen mesh from the flexible screen frame as it passes.

In operation, a flexible screen frame with excess mesh is placed on screen frame supporting assembly 26 of mesh trimmer 20.

Infeed fence 42 supports the flexible screen frame on a longest side thereof. The flexible screen frame comes into contact with supporting rollers 46 and is held in place and in contact with supporting rollers 46 by the magnetic influence of supporting magnets 48.

Mechanical frame hold down 70 is activated and advances hold down shaft 74 which contact the flexible screen frame and resists any tendency for the flexible screen frame to move away from infeed fence 42. As the flexible screen frame is advanced parallel to infeed fence 40, rotating blades 52 of trimmer head 57 sever screen mesh that extends substantially beyond the perimeter of the flexible screen frame. The excess mesh falls away from the flexible screen frame.

The flexible screen frame is advanced manually or by mechanical drive until hold down shaft 74 abuts an inside corner of the flexible screen frame. The flexible screen frame is then rotated until a second side of the flexible screen frame contacts at least a portion of infeed fence 42. In the depicted embodiment rotation is counterclockwise. Of course, one skilled in the art could reverse the configuration, in which case rotation would be clockwise. The flexible screen frame is then advanced parallel to infeed fence 42 in a similar fashion for the second side and further sides following further rotations. When all sides of the flexible screen frame have been trimmed hold down shaft 74 is retracted to facilitate removal of the flexible screen frame. The magnetic influence of supporting magnets 48 holds the flexible screen frame against supporting rollers 46 to facilitate proper support proper alignment and easy movement of the flexible screen frame for trimming.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to producenumerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. An excess screen mesh trimmer to trim excess mesh from a flexible screen frame to which the mesh is at least partially fused, comprising:
a trimmer assembly including at least a first rotating blade having a sharpened outer perimeter edge, the perimeter edge lying in a plane;
a screen frame supporting assembly that supports the flexible screen frame proximate the trimmer assembly and proximate the at least first rotating blade perimeter edge in a parallel orientation to a portion of the screen frame; and
a supporting frame that supports the trimmer assembly and the screen frame supporting assembly.

2. The excess screen mesh trimmer as claimed in claim 1, wherein the trimmer assembly comprises the first rotating blade and a second contrarotating blade, the perimeters of which are positioned to intersect each other.

3. The excess screen mesh trimmer as claimed in claim 2, wherein the trimmer assembly further comprises a trimmer motor and a trimmer transmission that drive the first rotating blade and the second contrarotating blade.

4. The excess screen mesh trimmer as claimed in claim 1, wherein the first a rotating blade is polygonal in shape and a second counter rotating blade is also polygonal in shape.

5. The excess screen mesh trimmer as claimed in claim 1, further comprising an infeed fence and an outfeed fence wherein the at least one of the infeed fence and the outfeed fence is trapezoidal in shape.

6. The excess screen mesh trimmer as claimed in claim 1, further comprising screen frame supporting rollers and magnets, at least some of the magnets being alternately interposed with at least some of the supporting rollers.

7. The excess screen mesh trimmer as claimed in claim 6, wherein the magnets are positioned such that the magnets do not contact the screen frame material but the screen frame material is within the attractive magnetic influence of the magnets.

8. The excess screen mesh trimmer as claimed in claim 5, wherein the infeed fence is trapezoidal in shape and the outfeed fence is linear.

9. The excess screen mesh trimmer as claimed in claim 5, wherein a first length of the infeed fence is shorter than a second length of a shortest side of a flexible screen frame intended to be trimmed or wherein a third length of the outfeed fence is shorter that the second length of the shortest length of side of the flexible screen frame intended to be trimmed.

10. The excess screen mesh trimmer as claimed in claim 1, further comprising:
at least one of a hold down assembly that holds the flexible screen frame against at least one of an infeed fence and an outfeed fence; or
a drive mechanism that frictionally engages the flexible screen frame and advances the flexible screen frame relative to the trimmer assembly.

11. A method of trimming excess screen mesh from a flexible screen frame, comprising:
placing the flexible screen frame in contact with a portion of an infeed fence and proximate a series of supporting rollers;
advancing the flexible screen frame in a direction parallel to the portion of the infeed fence;
bringing the excess screen mesh into contact with a trimmer head including at least one rotating cutter;
severing the excess screen mesh from the flexible screen frame proximate the flexible screen frame;
reaching a corner of the flexible screen frame;
rotating the flexible screen frame until an adjacent side of the flexible screen frame is parallel to the infeed fence and in contact with a portion of the infeed fence; and
advancing a second side of the flexible screen frame parallel to the portion of the infeed fence.

12. The method as claimed in claim 11, further comprising bringing the excess screen mesh into contact with two contrarotating rotating cutters.

13. The method as claimed in claim 11, further comprising bringing the excess screen mesh into contact with two rotating cutters that are polygonal in shape.

14. The method as claimed in claim 11, further comprising resting the flexible screen frame against at least one of the infeed fence and an outfeed fence with the flexible screen frame in a substantially vertical orientation.

15. The method as claimed in claim 11, further comprising resting the flexible screen frame against supporting rollers and within the attractive influence of magnets that are positioned such that the magnets do not contact the flexible screen frame material.

16. The method as claimed in claim 11, further comprising advancing the flexible screen frame relative to the trimmer head manually.

17. The method as claimed in claim 11, further comprising advancing the flexible screen frame relative to the trimmer head by engagement with a screen frame drive mechanism.

18. The method as claimed in claim 11, further comprising placing the screen frame in contact with a screen frame supporting assembly that is oriented from zero to fifteen degrees from absolute vertical.

19. The method as claimed in claim 11, further comprising supporting a portion of the excess screen mesh proximate a top of the flexible screen frame to mitigate the excess screen mesh from flopping downwardly.

20. A method of trimming excess screen mesh from a flexible screen frame, comprising:
placing the flexible screen frame in contact with a portion of an infeed fence and proximate a series of supporting rollers;
advancing the flexible screen frame in a direction parallel to the portion of the infeed fence;
bringing the excess screen mesh into contact with a trimmer head including two contrarotating cutters;
severing the excess screen mesh from the flexible screen frame proximate the flexible screen frame;
reaching a corner of the flexible screen frame;
rotating the flexible screen frame until an adjacent side of the flexible screen frame is parallel to the infeed fence; and
advancing a second side of the flexible screen frame parallel to the portion of the infeed fence.

21. The method as claimed in claim 20, further comprising resting the flexible screen frame against supporting rollers and within the attractive influence of magnets that are positioned such that the magnets do not contact the flexible screen frame material.
